(19) United States
(12) Patent Application Publication
(10) Pub. No.: US 2023/0308593 A1
(43) Pub. Date: Sep. 28, 2023

(54) NON-TRANSITORY COMPUTER READABLE RECORDING MEDIUM RECORDING PROGRAM AND INFORMATION PROCESSING APPARATUS

(71) Applicant: FUJIFILM Business Innovation Corp., Tokyo (JP)

(72) Inventors: Daichi KUROTSU, Kanagawa (JP); Yuichi Nishikuni, Kanagawa (JP); Koichi Matsubara, Kanagawa (JP); Shinya Takaishi, Kanagawa (JP)

(73) Assignee: FUJIFILM Business Innovation Corp., Tokyo (JP)

(21) Appl. No.: 18/177,761

(22) Filed: Mar. 3, 2023

(30) Foreign Application Priority Data
Mar. 28, 2022 (JP) 2022-051713

(51) Int. Cl. H04N 1/60; H04N 1/00; G06T 5/50; G06V 10/56

(52) U.S. Cl. CPC H04N 1/60; H04N 1/0044; G06T 5/50; G06V 10/56; G06T 2207/10024; G06T 2207/20221

(57) ABSTRACT

A non-transitory computer readable recording medium records program for causing a computer that reproduces an image of a printed matter before printing and displays the image on a screen to implement: a changing function of, in a case where a first image generated according to a density value of a color material and a second image representing a surface of a sheet to be used for printing are combined to generate an image of a printed matter, changing appearance of the second image, according to a total amount of the color material to be used for printing the corresponding first image, for each pixel position.

### CROSS-REFERENCE TO RELATED APPLICATIONS

This application is based on and claims priority under 35 USC 119 from Japanese Patent Application No. 2022-051713 filed Mar. 28, 2022.

### BACKGROUND

### (i) Technical Field

The present invention relates to a non-transitory computer readable recording medium recording program and an information processing apparatus.

### (ii) Related Art

The tint of an image to be printed may be checked on a screen before printing. A preview function is used for this checking purpose. Checking the tint before printing reduces waste of sheets and color materials.

Currently, various types of sheets are used for printing in addition to sheets having uniform surface characteristics. For example, a sheet having a surface with different shades or different glossiness depending on positions or a sheet having an uneven surface may be used for printing.

The conventional preview function adopts a method of simply combining an image of print data with an image representing a surface of a sheet. Thus, a preview image is formed regardless of the presence or absence of color materials or the difference in the total amount of color materials used for image formation.

Therefore, even at a position where the total amount of color materials used for image formation is large, the state of the surface of the sheet is represented in the preview image similarly to the position where the total amount of color materials is small.

However, in practice, as the total amount of color materials increases except for special color materials such as a transparent color material, the state of the surface of the sheet is less visible due to a masking effect.

### SUMMARY

Aspects of non-limiting embodiments of the present disclosure relate to a non-transitory computer readable recording medium recording program that improves reproducibility of an image of a printed matter displayed on a screen, compared to a case where a masking effect due to an increase in a total amount of a color material used for image formation is not reflected in appearance of the image of the printed matter.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a non-transitory computer readable recording medium recording program for causing a computer that reproduces an image of a printed matter before printing and displays the image on a screen to implement: a changing function of, in a case where a first image generated according to a density value of a color material and a second image representing a surface of a sheet to be used for printing are combined to generate an image of a printed matter, changing appearance of the second image according to a total amount of the color material to be used for printing the first image, for each pixel position correspondingly.

### BRIEF DESCRIPTION OF THE DRAWINGS

FIG. 1 is a view illustrating a configuration example of a printing system used in an exemplary embodiment.

FIG. 2 is a diagram illustrating an example of a hardware configuration of a control apparatus.

FIG. 3 is a diagram illustrating an example of a data structure of a DLUT.

FIG. 4 is a diagram illustrating an example of a functional configuration of the control apparatus.

FIG. 5 is a flowchart illustrating an example of a processing operation related to the display of a preview image performed by the control apparatus.

FIG. 6 is a diagram illustrating an example of an arithmetic expression used to calculate a pixel value [RGB] of a preview image.

FIG. 7 is a diagram illustrating an example of a sheet having a small change in surface characteristics and an example of a sheet having a large change in surface characteristics. (A) and (C) illustrate sheets with a small change, and (B) and (D) illustrate sheets with a large change.

FIG. 8 is a diagram illustrating an example of generation of a composite image in which input image data is combined on a sheet having a small change in surface characteristics. (Al) illustrates an example of a pixel without input image data, (A2) illustrates an example of a composite image of pixels without input image data, (B1) illustrates an example of a pixel with a total amount of toner of 200% in input image data, (B2) illustrates an example of a composite image of pixels with a total amount of toner of 200%, (C1) illustrates an example of a pixel with a total amount of toner of 300% in input image data, and (C2) illustrates an example of a composite image of pixels with a total amount of toner of 300%.

FIG. 9 is a diagram illustrating an example of generation of a composite image in which input image data is combined on a sheet having a large change in surface characteristics. (A1) illustrates an example of a pixel without input image data, (A2) illustrates an example of a composite image of pixels without input image data, (B1) illustrates an example of a pixel with a total amount of toner of 200% in input image data, (B2) illustrates an example of a composite image of pixels with a total amount of toner of 200%, (C1) illustrates an example of a pixel with a total amount of toner of 300% in input image data, and (C2) illustrates an example of a composite image of pixels with a total amount of toner of 300%.

FIG. 10 is a graph illustrating a relationship between α and the total amount of toner for a sheet having a small change in surface characteristics.

FIG. 11 is a diagram illustrating an example of generation of a composite image in which input image data is combined on a sheet having a small change in surface characteristics. (A1) illustrates an example of a pixel without input image data, (A2) illustrates an example of a composite image of pixels without input image data, (B1) illustrates an example of a pixel with a total amount of toner of 200% in input image data, (B2) illustrates an example of a composite image of pixels with a total amount of toner of 200%, (C1) illustrates an example of a pixel with a total amount of toner of 300% in input image data, and (C2) illustrates an example of a composite image of pixels with a total amount of toner of 300%.

FIG. 12 is a graph illustrating a relationship between a and the total amount of toner for a sheet having a large change in surface characteristics.

FIG. 13 is a diagram illustrating an example of generation of a composite image in which input image data is combined on a sheet having a large change in surface characteristics. (A1) illustrates an example of a pixel without input image data, (A2) illustrates an example of a preview image of pixels without input image data, (B1) illustrates an example of a pixel with a total amount of toner of 200% in input image data, (B2) illustrates an example of a preview image of pixels with a total amount of toner of 200%, (C1) illustrates an example of a pixel with a total amount of toner of 300% in input image data, and (C2) illustrates an example of a preview image of pixels with a total amount of toner of 300%.

FIG. 14 is a flowchart illustrating an example of a processing operation related to the display of a preview image performed by the control apparatus.

FIG. 15 is a diagram illustrating an example of an arithmetic expression used for correcting normal vector data used in step 12.

FIG. 16 is a diagram illustrating correction of a normal map. (A) illustrates an uneven shape in a case where the total amount of toner is small, (B) illustrates an uneven shape after correction in a case where the total amount of toner is medium, and (C) illustrates an uneven shape after correction in a case where the total amount of toner is large.

FIGS. 17A and 17B are diagrams each illustrating an example of preview images displayed when a plurality of patterns with different total toner amounts are printed on a sheet having unevenness formed on a surface thereof. FIG. 17A illustrates a display example in a case where the normal map data of the sheet is corrected and used, and FIG. 17B illustrates a display example in a case where the normal map data of the sheet is used as it is.

FIG. 18 is a flowchart illustrating an example of a processing operation related to the display of a preview image performed by the control apparatus.

### DETAILED DESCRIPTION

Hereinafter, exemplary embodiments of the present invention will be described with reference to the drawings.

### <First Exemplary Embodiment>

### <System Configuration>

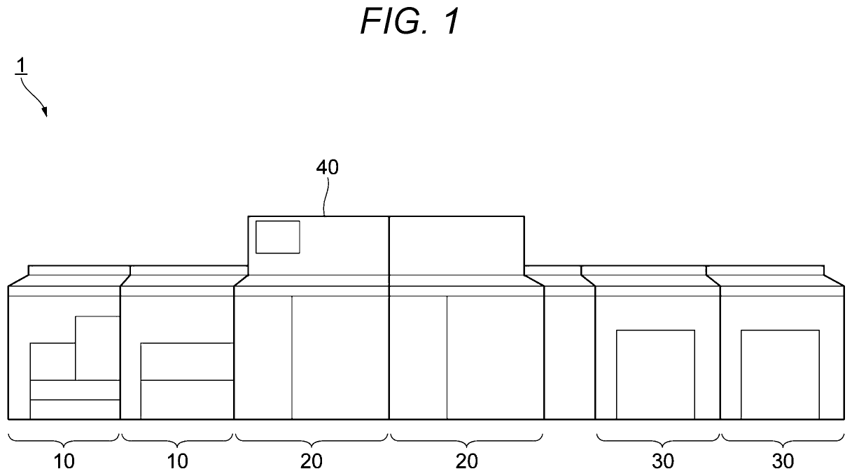

FIG. 1 is a view illustrating a configuration example of a printing system 1 used in a first exemplary embodiment.

The printing system 1 illustrated in FIG. 1 includes a sheet feeder 10, a print apparatus 20, a post-processing apparatus 30, and a control apparatus 40.

The printing system 1 is an example of an image forming system, the print apparatus 20 is an example of an image forming apparatus, and the control apparatus 40 is an example of an information processing apparatus.

The printing system 1 illustrated in FIG. 1 is also called a production printer. However, the printing system 1 is not limited to a production printer, and may be a printer used in an office or a printer used at home. A printer used in an office is provided with a scanner function, a FAX transmission and reception function, and the like in addition to a print function. A difference between a printer used in an office and a printer used at home is mainly performance.

In the printing system 1 illustrated in FIG. 1, two sheet feeders 10 are connected in series.

The sheet feeder 10 feeds a sheet to the print apparatus 20. In the present exemplary embodiment, cut sheets are stored in the sheet feeder 10. The sheet feeder 10 stores, for example, 7000 cut sheets. However, the sheet stored in the sheet feeder 10 is not limited to the cut sheet and may be a rolled sheet. In the present exemplary embodiment, the sheet is not limited to a so-called white sheet (hereinafter also referred to as a “blank sheet”), and may be a sheet of which the color density, the glossiness, and the unevenness vary depending on the position. The latter sheet is also referred to as “special paper”. Examples of the special paper include pearl paper, Japanese paper, and embossed paper. The difference in impression due to the difference in glossiness is also referred to as brilliance. A sheet is one example of a recording medium.

In the printing system 1 illustrated in FIG. 1, two print apparatuses 20 are connected in series. The print apparatus 20 according to the present exemplary embodiment includes an engine (hereinafter also referred to as a “print engine”) that prints an image on a sheet using an electrophotographic method.

The print engine prints an image on a sheet through processes of charging, exposure, development, transfer, and fixing. The print engine is an example of a forming unit that forms an image on a sheet by using a plurality of color materials. The image is not limited to a so-called diagram or photograph, and includes characters. Hereinafter, the drawing or the photograph formed on the surface of the sheet is also referred to as an object.

The print apparatus 20 according to the present exemplary embodiment is capable of performing printing using four types of toners corresponding to basic colors and one or two types of special color toners. Examples of the special color toner include a metallic color toner and a fluorescent toner.

The toner used in the print apparatus 20 is an example of a color material.

The print apparatus 20 according to the present exemplary embodiment has a function of performing printing on both sides of a sheet in addition to a function of performing printing on one side of a sheet. The sheet on which the image is printed is referred to as a printed matter.

In the printing system 1 illustrated in FIG. 1, two post-processing apparatuses 30 are connected in series. The post-processing apparatus 30 includes, for example, a process of discharging printed matters of the same page while shifting their positions (that is, a stack process), a stapling process of binding a plurality of sheets with a staple, and a process of binding a plurality of sheets with an adhesive tape.

The control apparatus 40 is an apparatus that controls the movement of the print apparatus 20 and the like. The control apparatus 40 controls, for example, reading of a direct look-up table (DLUT), management of a print job or data used for printing, and raster image processor (RIP) processing.

The DLUT is a table in which density values of toners corresponding to respective colors are associated with values to be used for calculation of display colors. The DLUT is an example of a conversion table.

The control apparatus 40 also controls the generation of a preview image that reproduces the tint of the printed matter before printing using the above-described DLUT.

In FIG. 1, the control apparatus 40 is disposed at the upper part of a casing of the print apparatus 20, but the control apparatus 40 may be disposed in the casing of the print apparatus 20.

The print job means a job for instructing to print a document. One print job includes a data file of a document to be printed (hereinafter also referred to as “document data”). The document data may have any data format. The image corresponding to the document data is an example of a “first image”.

The document data includes an electronic document generated by an application program (hereinafter referred to as “application”) and a digital document generated from a paper document.

Examples of the electronic document include electronic data generated by a so-called office application, electronic data generated by a drawing application, electronic data generated by an accounting application, and a web page displayed on an application (that is, a browser) for browsing a website.

Examples of the digital document include electronic data output from a scanner and electronic data output from a camera.

The document data according to the present exemplary embodiment includes objects such as figures and characters, and a color is set for each object. The color of an object is given by, for example, density values of cyan (C), magenta (M), yellow (Y), black (K), and a special color.

The density value in the present exemplary embodiment is expressed by, for example, 0% to 100% or 0 to 255. 0% or 0 indicates the minimum density value, and 100% or 255 indicates the maximum density value.

### <Configuration of Control Apparatus>

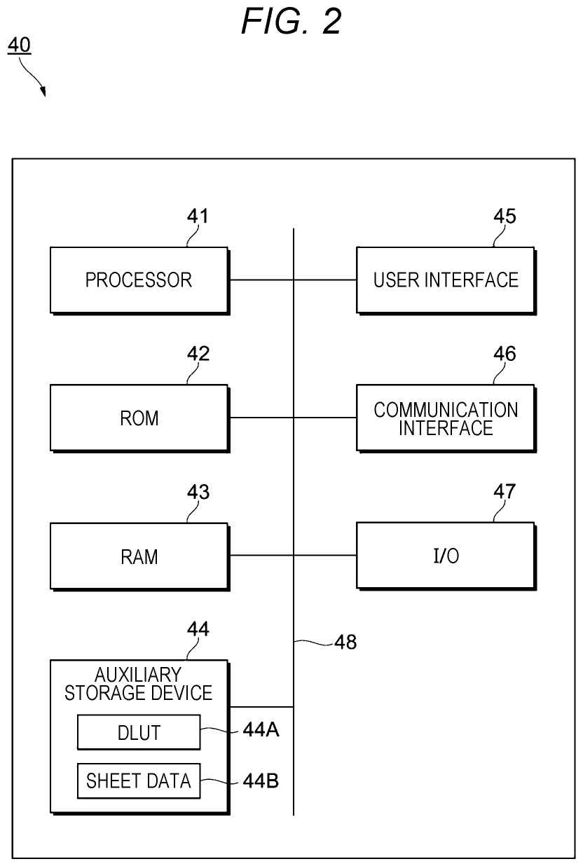

FIG. 2 is a diagram illustrating an example of a hardware configuration of the control apparatus 40.

The control apparatus 40 illustrated in FIG. 2 includes a processor 41, a read only memory (ROM) 42 in which a basic input output system (BIOS) or the like is stored, a random access memory (RAM) 43 used as a work area of the processor 41, an auxiliary storage device 44, a user interface 45, a communication interface 46, and an input/output (I/O) 47. Each unit of the control apparatus 40 is connected through a bus or other signal lines 48.

The processor 41 is a device that implements various functions through execution of a program.

The processor 41 in the present exemplary embodiment implements various functions through execution of a program. The processor 41, ROM 42, and RAM 43 function as a computer.

The auxiliary storage device 44 is, for example, a hard disk device or a semiconductor storage. The auxiliary storage device 44 is used to store programs, print jobs, and the like. The program is used as a general term for an operating system (OS) or an application program.

The auxiliary storage device 44 also stores sheet data 44B and DLUT 44A for converting the density value of each color given by the document data into a display color to be observed when printed on sheet.

In the present exemplary embodiment, the DLUT 44A is prepared for each type of sheet, for example.

The sheet data 44B according to the present exemplary embodiment includes data of a captured image of the surface of a sheet (hereinafter referred to as “sheet image data”), data of the glossiness of the surface of a sheet (hereinafter referred to as “glossiness data”), and data of a normal map representing unevenness of the surface of a sheet (hereinafter referred to as “normal map data”). The sheet image data, the glossiness data, and the normal map data are prepared for ach of all pixel positions corresponding to the surface of the sheet. The sheet image data may not be the captured image data, and may be image data synthesized by, for example, image creation software as long as the image data represents the surface of the sheet.

The sheet image data is an example of a “second image” obtained by capturing an image of a surface of a sheet.

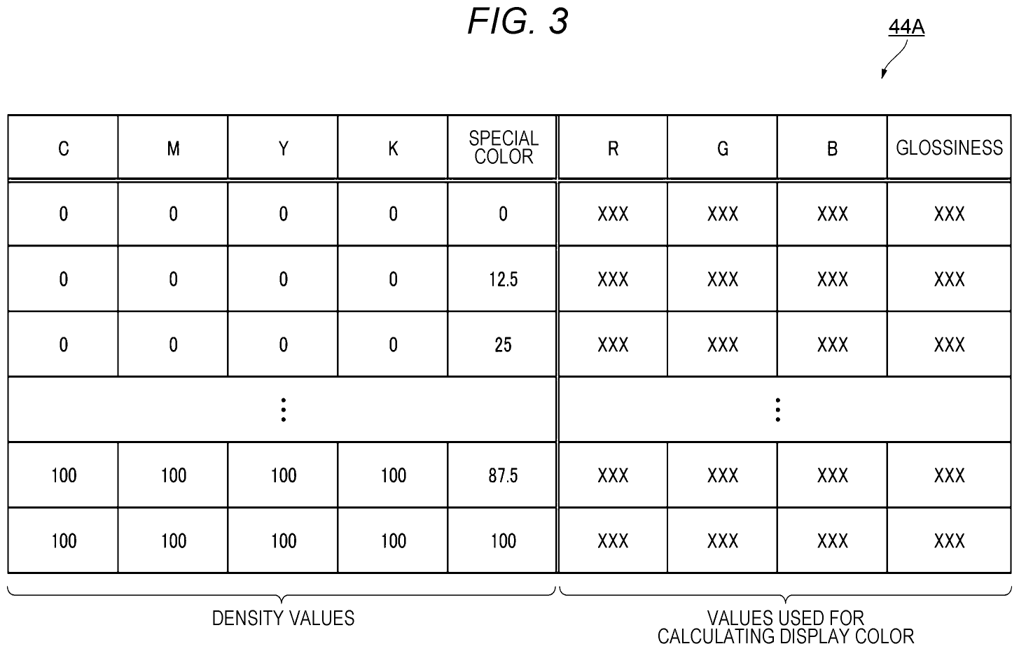

FIG. 3 is a diagram illustrating an example of a data structure of the DLUT 44A.

The left column of the data structure corresponds to the density values defined in the document data, and the right column corresponds to the values used for calculating the display color.

In FIG. 3, density values are given by the cyan (C), magenta (M), yellow (Y), black (K), and special colors.

On the other hand, the values used for calculating the display color are given by the tone values of red (R), green (G), and blue (B) and the glossiness. The tone value may be referred to as a “signal value”. The tone value is expressed by, for example, 0 to 255. 0 is the minimum value, and 255 is the maximum value. The glossiness is expressed by, for example, 0% to 100%. 0% is the minimum value, and 100% is the maximum value.

In FIG. 3, specific numerical values are omitted.

FIG. 2 will be described below again.

The user interface 45 is an interface that receives an operation of a user who uses the print apparatus 20. The user interface 45 includes, for example, an input unit such as an operation button or a touch sensor that detects an operation by a fingertip of the user, and a display unit such as a liquid crystal display or an organic electro-luminescent (EL) display.

The communication interface 46 is an interface for communicating with other terminals or the like. The communication interface 46 uses a wired or wireless communication method. As a communication standard of the communication interface 46, for example, Ethernet (registered trademark), Wi-Fi (registered trademark), or the like is used.

The I/O 47 is used for communication between the processor 41 and the print apparatus 20 (see FIG. 1).

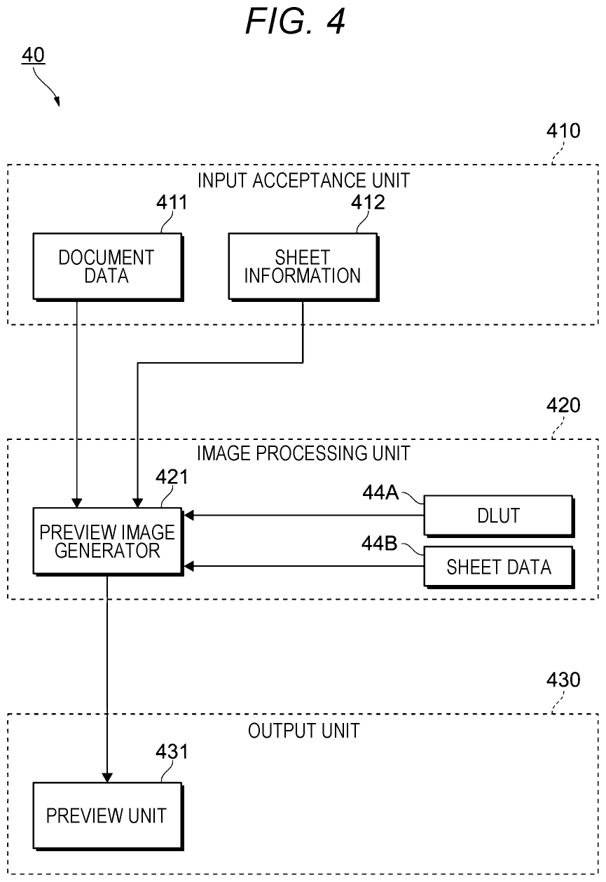

FIG. 4 is a diagram illustrating an example of a functional configuration of the control apparatus 40. The functional units illustrated in FIG. 4 are implemented through the execution of a program by the processor 41 (see FIG. 2).

The functional units illustrated in FIG. 4 are roughly classified into an input acceptance unit 410, an image processing unit 420, and an output unit 430.

The input acceptance unit 410 is a functional unit that accepts information necessary for predicting a tint of a printed matter.

In FIG. 4, the input acceptance unit 410 accepts input of document data 411 and sheet information 412.

The document data 411 is, for example, a color chart in which a plurality of colors having different tints are arranged in a matrix.

The sheet information 412 is given by sheet image data, glossiness data, and normal map data.

The sheet image data is given by, for example, density values of cyan (C), magenta (M), yellow (Y), and black (K). The normal map data representing the shadow appearing due to the unevenness of the surface of the sheet is prepared independently of the sheet image data.

The image processing unit 420 is a functional unit that generates a preview image for predicting the tint of a printed matter.

In FIG. 4, the image processing unit 420 includes a preview image generator 421, the DLUT 44A, and the sheet data 44B.

The preview image generator 421 is a functional unit that implements a function of converting a color on document data into a color on sheet using the DLUT 44A and a function of changing appearance of an image on sheet as a base of the image in accordance with a total amount of toner used for printing each pixel.

The term “pixel” in the present exemplary embodiment refers to a unit of area used to calculate the total amount of toner used for printing. Therefore, the area does not necessarily match the area of the pixels constituting the display unit displaying the preview image.

The total amount of toner refers to the sum of density values of one or more toners used for printing each pixel. For example, the total amount of toner of a pixel printed only in black (K) matches the density value of black (K). On the other hand, the total amount of toner of pixels printed in cyan (C), magenta (M), and yellow (Y) is calculated as the sum of the density value of cyan (C), the density value of magenta (M), and the density value of yellow (Y).

The preview image generator 421 generates a preview image using the DLUT 44A and the sheet data and outputs the generated preview image to the output unit 430.

The output unit 430 is a functional unit that displays a preview image for predicting the tint of a printed matter on a display unit. In FIG. 4, the output unit 430 includes a preview unit 431. The preview unit 431 displays the preview image generated by the preview image generator 421 on the display unit. The preview image in the present exemplary embodiment is displayed three dimensionally.

### <Processing Operation Example>

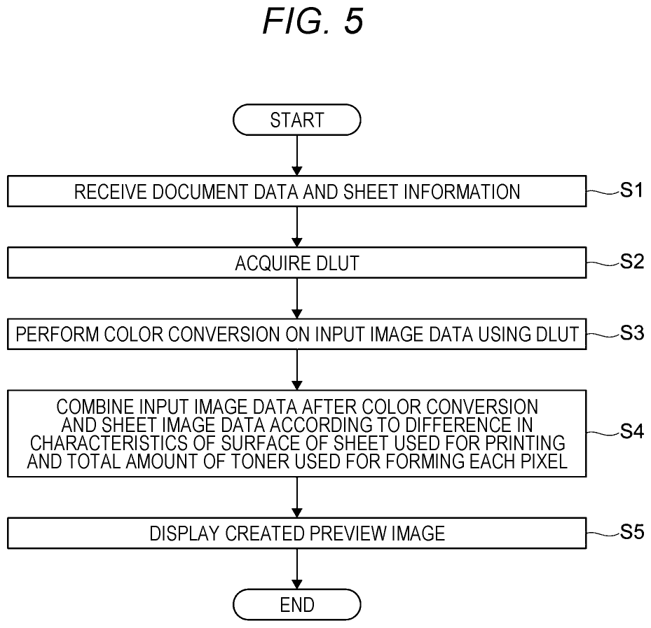

FIG. 5 is a flowchart illustrating an example of a processing operation related to display of a preview image performed by the control apparatus 40 (see FIG. 1). The symbol S illustrated in the figure means a step.

The processing operation illustrated in FIG. 5 is controlled through the execution of a program by the processor 41 (see FIG. 2).

The processing operation illustrated in FIG. 5 is started in a case where the processor 41 receives display of a preview image reproducing a tint of a printed matter before printing, for example.

First, the processor 41 receives the document data 411 (see FIG. 4) and the sheet information 412 (see FIG. 4) (step 1).

Hereinafter, the data of the input image corresponding to the document data 411 is referred to as “input image data”. The input image data is given by density values of cyan (C), magenta (M), yellow (Y), black (K), and a special color.

The sheet information 412 is given by sheet image data, glossiness data, and normal map data.

Next, the processor 41 acquires the DLUT 44A (step 2). The DLUT 44A is stored in the auxiliary storage device 44 (see FIG. 2).

Subsequently, the processor 41 performs color conversion on the input image data using the DLUT 44A (step 3). To be specific, the processor 41 assigns each pixel value of the input image data to the DLUT 44A, and reads out corresponding tone values of red (R), green (G), and blue (B) and glossiness.

With the color conversion performed here, an image is generated that reproduces the tone in the case where document data is printed on sheet.

Next, the processor 41 combines the input image data after color conversion and the sheet image data according to the difference in the characteristics of the surface of the sheet used for printing and the total amount of toner used for forming each pixel (step 4).

Examples of the characteristics of the surface of the sheet include the color density appearing on the surface of the sheet, the glossiness appearing on the surface of the sheet, and the height of unevenness appearing on the surface of the sheet.

In the present exemplary embodiment, a reference for determination is set for each sheet, and a combining method is switched in accordance with a sheet exceeding the reference and a sheet not exceeding the reference.

For example, the standard deviation or the variance of the characteristics used for the determination is calculated for the entire sheet, and it is determined whether or not the calculated value exceeds the corresponding reference.

According to this determination, a sheet having a small change in color density over the entire sheet, a sheet having a small change in glossiness over the entire sheet, a sheet having a small height of unevenness over the entire sheet, a sheet having a large change in color density over the entire sheet, a sheet having a large change in glossiness over the entire sheet, and a sheet having a large height of unevenness over the entire sheet are determined.

In a case where the preview image is created by the composition processing of the input image data and the sheet image data, the processor 41 displays the created preview image (step 5).

In the present exemplary embodiment, the preview image is displayed on the display unit of the control apparatus 40.

### <Preview Image Creation Processing>

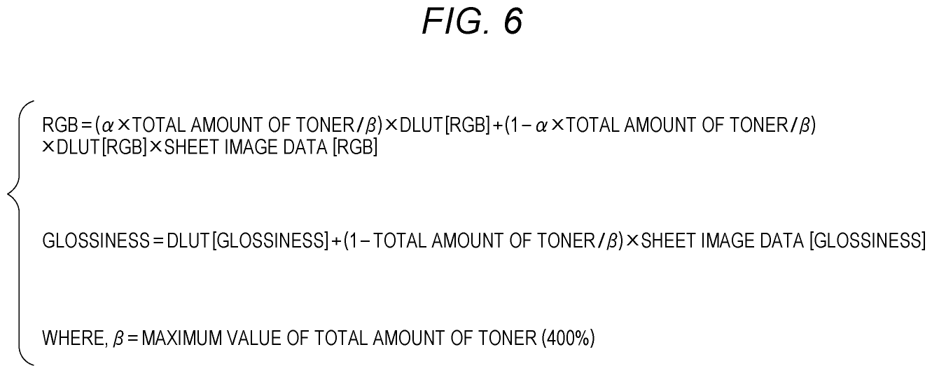

FIG. 6 is a diagram illustrating an example of an arithmetic expression used to calculate a pixel value [RGB] of a preview image.

RGB=(α×total amount of toner)/β×DLUT [RGB]+(1−α×total amount of toner/β)×DLUT [RGB]×sheet image data [RGB]

Glossiness=DLUT [glossiness]+(1−total amount of toner/β)×sheet image data [glossiness]

Here, β is the maximum value of the total amount of toner. In the present exemplary embodiment, β is 400%.

### [RGB Value]

“DLUT [RGB]” in the first term corresponds to an RGB value of the input image. The input image is an example of the first image.

“DLUT [RGB]×sheet image data [RGB]” in the second term corresponds to an RGB value of an image (hereinafter, referred to as a “composite image”) obtained by combining the input image data and the sheet image data.

### [Glossiness]

“DLUT [glossiness]” in the first term corresponds to the glossiness of the input image.

“Sheet image data [glossiness]” in the second term corresponds to the glossiness of the sheet image. The sheet image is an example of the second image.

It is to be noted that “α×total amount of toner/β” is a normalized value of the total amount of toner in each pixel. The normalized value is an example of the “size of the total amount of toner”.

In a case where the normalized value is denoted by M, the RGB value is calculated as a value obtained by combining the input image and the composite image at the ratio of M:1-M.

On the other hand, the glossiness is calculated as a value obtained by combining the glossiness of the input image and the glossiness of the sheet image at the ratio of 1:1-M. That is, the composition ratio of the sheet images is inversely proportional to the total amount of toner.

In the present exemplary embodiment, as the total amount of toner increases, the proportion of the input image increases, and the RGB values of the preview image finally become only the input image.

Regarding the glossiness of the preview image, the component of the glossiness of the input image is always constant, but the ratio of the glossiness of the sheet decreases as the total amount of toner increases and finally becomes 0.

In some cases, α is a fixed value or a variable according to the total amount of toner. In either case, it is desirable to appropriately use the sheet according to the difference in the characteristics of the surface of the sheet.

### <Display Example of Preview Image>

A display example of a preview image according to the present exemplary embodiment will be described with reference to a difference in display of a preview image due to a difference in surface characteristics of sheets and a difference in total amount of toner.

### <Example of Sheet>

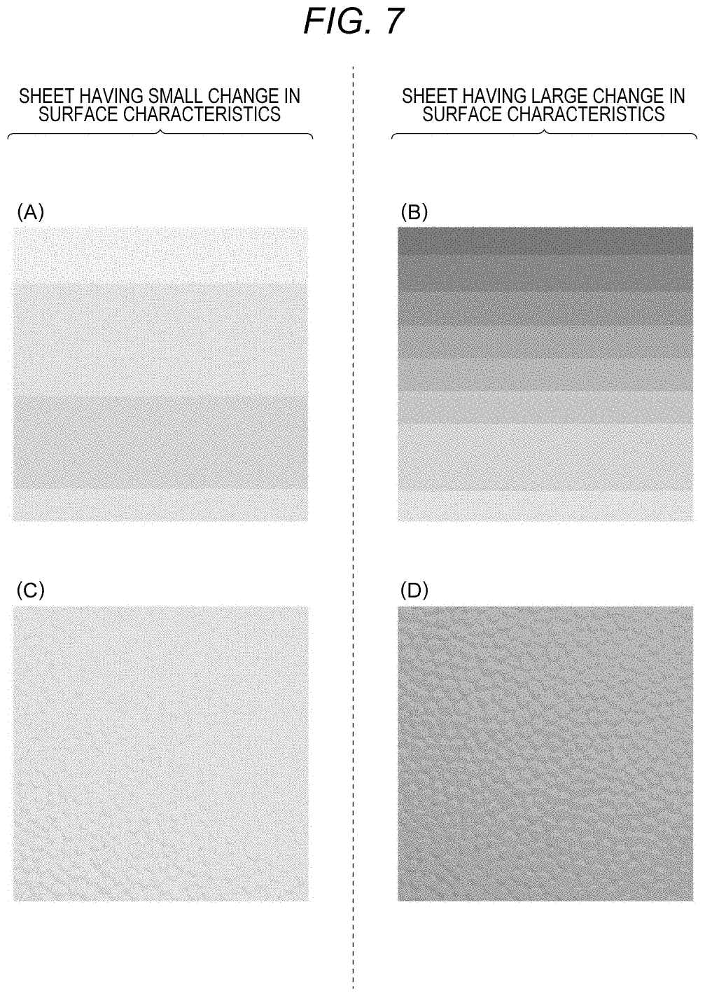

FIG. 7 is a diagram illustrating an example of the sheet having a small change in surface characteristics and an example of the sheet having a large change in surface characteristics. (A) and (C) illustrate sheets with a small change, and (B) and (D) illustrate sheets with a large change.

The sheet illustrated in (A) and (B) of FIG. 7 has color density. The sheets illustrated in (C) and (D) of FIG. 7 have different heights of unevenness. The unevenness of the sheet having high unevenness stands out as a pattern, but the unevenness of the sheet having low unevenness does not stand out as a pattern.

The change in shade of the sheet illustrated in (A) of FIG. 7 is small, but the change in shade of the sheet illustrated in (B) of FIG. 7 is large. The same applies to the change in the glossiness.

The unevenness on the sheet illustrated in (C) of FIG. 7 is low, but the unevenness on the sheet illustrated in (D) of FIG. 7 is high.

Hereinafter, the sheet having low unevenness is treated as an example of a sheet having a small change in surface characteristics. The sheet having high unevenness is treated as an example of a sheet having a large change in surface characteristics.

### <α is Fixed Value/Sheet Having Small Change in Surface Characteristics>

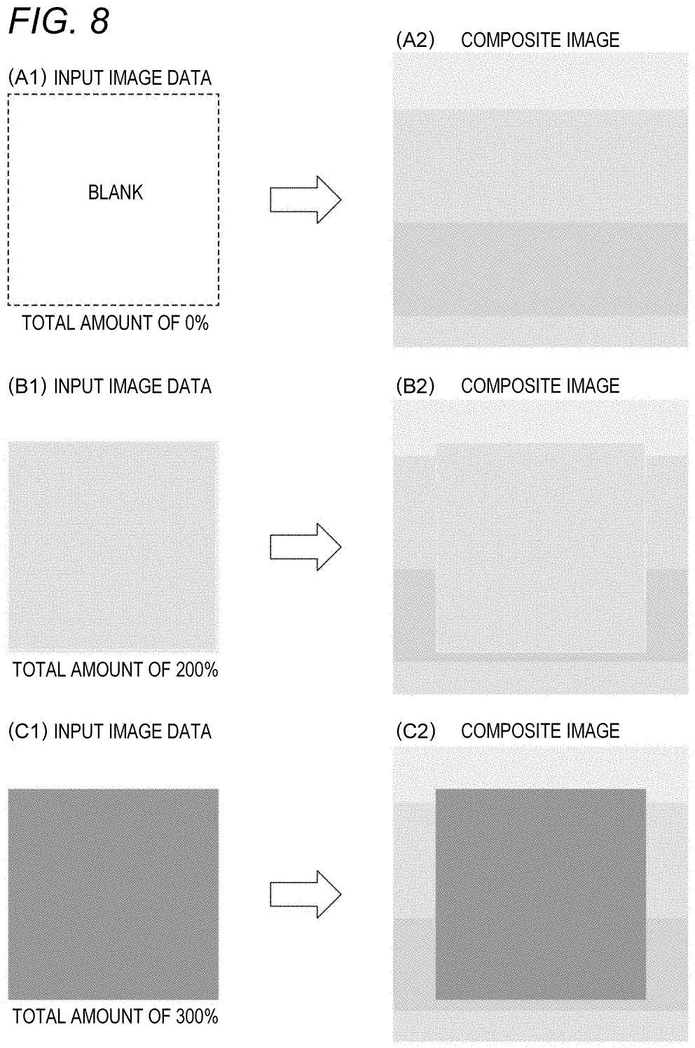

FIG. 8 is a diagram illustrating an example of generation of a composite image in which input image data is combined on a sheet having a small change in surface characteristics. (A1) illustrates an example of a pixel without input image data, (A2) illustrates an example of a composite image of pixels without input image data, (B1) illustrates an example of a pixel with a total amount of toner of 200% in input image data, (B2) illustrates an example of a composite image of pixels with a total amount of toner of 200%, (C1) illustrates an example of a pixel with a total amount of toner of 300% in input image data, and (C2) illustrates an example of a composite image of pixels with a total amount of toner of 300%.

In (A2), (B2), and (C2) of FIG. 8, the sheet illustrated in (A) of FIG. 7 is assumed as an example of a sheet having a small change in surface characteristics.

Note that, in the case of a sheet having a small change in surface characteristics, the surface characteristics of the sheet become less conspicuous even in a pixel having a small total amount of toner, and the surface characteristics of the sheet become almost invisible as the total amount of toner increases. Therefore, the value of α is set to “1” or a value close to “1”. For example, α is set to a value equal to or greater than “0.8”.

(A1) and (A2) of FIG. 8 illustrate an input image and a composite image when the total amount of toner is 0%. In this case, only the sheet image is displayed as the preview image.

The RGB value and the glossiness of the composite image when the total amount of toner is in the range from 0% to 100% are given by the following equations.

RGB=M×DLUT [RGB]+(1−M)×DLUT [RGB]×sheet image data [RGB]

Glossiness=DLUT [glossiness]+(1−M)×sheet image data [glossiness]
M is the total amount of toner/β.

When the total amount of toner is within this range, M is 0.25 or less. Therefore, both the RGB value and the glossiness are greatly affected by the components of the sheet image.

(B1) and (B2) of FIG. 8 illustrate an input image and a composite image when the total amount of toner is 200%.

In this case, the RGB value and the glossiness of the composite image are given by the following expression. Here, α=1.

RGB=0.5×DLUT [RGB]+0.5×DLUT [RGB]×sheet image data [RGB]

Glossiness=DLUT [glossiness]+0.5×sheet image data [glossiness]

That is, it is possible to increase the ratio of the input image (that is, DLUT [RGB]) to the RGB value of the composite image compared to a case where the input image and the sheet image are simply combined (that is, DLUT [RGB] and sheet image data [RGB]). The influence of the glossiness of the sheet image is reduced.

(C1) and (C2) of FIG. 8 illustrate an input image and a composite image when the total amount of toner is 300%.

In this case, the RGB value and the glossiness of the composite image are given by the following expression. Here, α=1.

RGB=0.75×DLUT [RGB]+0.25×DLUT [RGB]×sheet image data [RGB]

Glossiness=DLUT [glossiness]+0.25×sheet image data [glossiness]

That is, as the total amount of toner increases, the proportion of the input image in the RGB values of the composite image further increases, and the proportion of surface components of the sheet image further decreases. As a result, a preview image close to the actual appearance can be displayed.

### <α is Fixed Value/Sheet Having Large Change in Surface Characteristics>

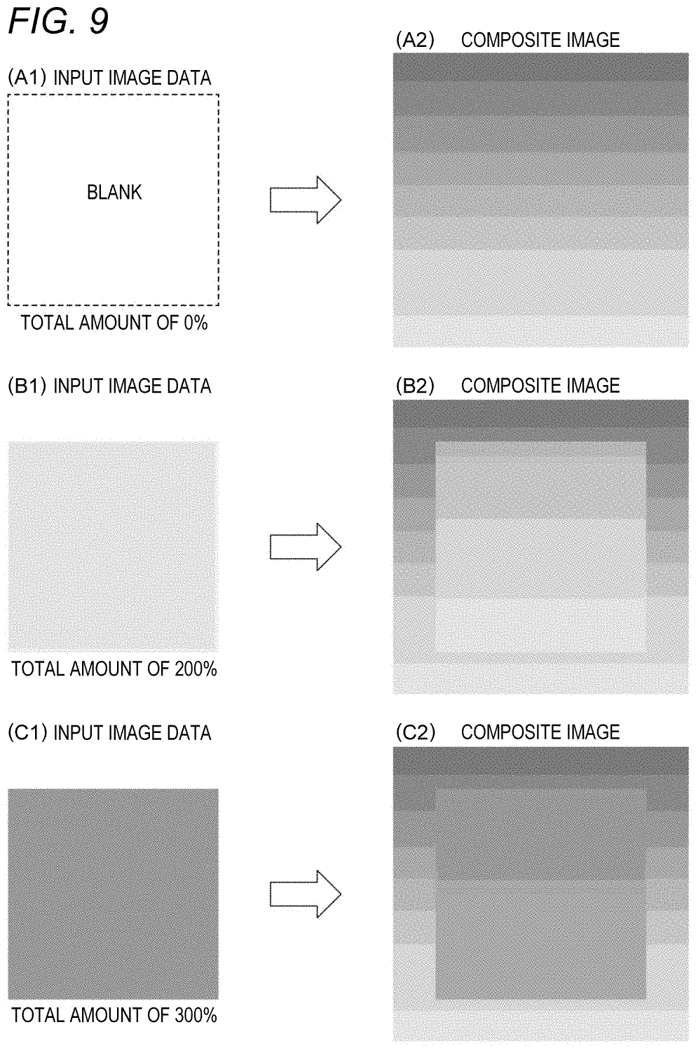

FIG. 9 is a diagram illustrating an example of generation of a composite image in which input image data is combined on a sheet having a large change in surface characteristics. (A1) illustrates an example of a pixel without input image data, (A2) illustrates an example of a composite image of pixels without input image data, (B1) illustrates an example of a pixel with a total amount of toner of 200% in input image data, (B2) illustrates an example of a composite image of pixels with a total amount of toner of 200%, (C1) illustrates an example of a pixel with a total amount of toner of 300% in input image data, and (C2) illustrates an example of a composite image of pixels with a total amount of toner of 300%.

In (A2), (B2), and (C2) of FIG. 9, the sheet illustrated in (B) of FIG. 7 is assumed as an example of a sheet having a large change in surface characteristics.

In the case of a sheet having a large change in surface characteristics, the RGB values of the surface characteristics of the sheet are larger than those of the sheet having a small change in surface characteristics. Therefore, the total amount of toner at which the influence of the surface of the sheet starts to decrease is larger than the total amount of toner at which the change in the characteristics of the surface of the sheet is small. Therefore, the value of α is set to “0.5” or a value close to “0.5”. For example, α is set to a value between “0.4” and “0.6” (inclusive).

(A1) and (A2) of FIG. 9 illustrate an input image and a composite image when the total amount of toner is 0%. In this case, only the sheet image is displayed in the composite image.

In this case, the RGB value and the glossiness of the composite image are given by the following expression. Here, a=0.5.

RGB=0.5×M×DLUT [RGB]+(1−0.5×M)×DLUT [RGB]×sheet image data [RGB]

Glossiness=DLUT [glossiness]+(1−M)×sheet image data [glossiness]

That is, the RGB values of the composite image include more components of the sheet image than those in (A2) of FIGS. 8.

(B1) and (B2) of FIG. 9 illustrate an input image and a composite image when the total amount of toner is 200%.

In this case, the RGB value and the glossiness of the composite image are given by the following expression. Here, α=0.5.

RGB=0.25×DLUT [RGB]+0.75×DLUT [RGB]×sheet image data [RGB]

Glossiness=DLUT [glossiness]+0.533 sheet image data [glossiness]

In the case of a sheet having a large change in surface characteristics, the RGB values of the composite image include three times the components of the sheet image of FIG. 8 (B2).

Therefore, the composite image illustrated in (B2) of FIG. 9 includes more components of the sheet image than the composite image illustrated in (B2) of FIG. 8.

The influence of the glossiness of the sheet image is larger than that in the case of (B2) of FIG. 8.

(C1) and (C2) of FIG. 9 illustrate an input image and a composite image when the total amount of toner is 300%.

In this case, the RGB value and the glossiness of the composite image are given by the following expression. Here, α=0.5.

RGB=0.375×DLUT [RGB]+0.625×DLUT [RGB]×sheet image data [RGB]

Glossiness=DLUT [glossiness]+0.2533 sheet image data [glossiness]

In the case of a sheet having a large change in surface characteristics, more components than those in (C2) of FIG. 8 are included in the sheet image.

However, when compared with a case where components (DLUT [RGB]×sheet image data [RGB]) obtained by simply combining the input image and the sheet image are displayed as a composite image, the components are reduced to 62.5%.

Moreover, only the component of the input image is added to the composite image. Thus, if the total amount of toner is the same, the proportion of components of the sheet image is smaller than that in the case where components (DLUT [RGB]×sheet image data [RGB]) obtained by simply combining the input image and the sheet image are displayed as a composite image. As a result, a preview image close to the actual appearance can be displayed.

### <α is Variable Value/Sheet Having Small Change in Surface Characteristics>

Here, a case in which a is varied in accordance with the total amount of toner will be described.

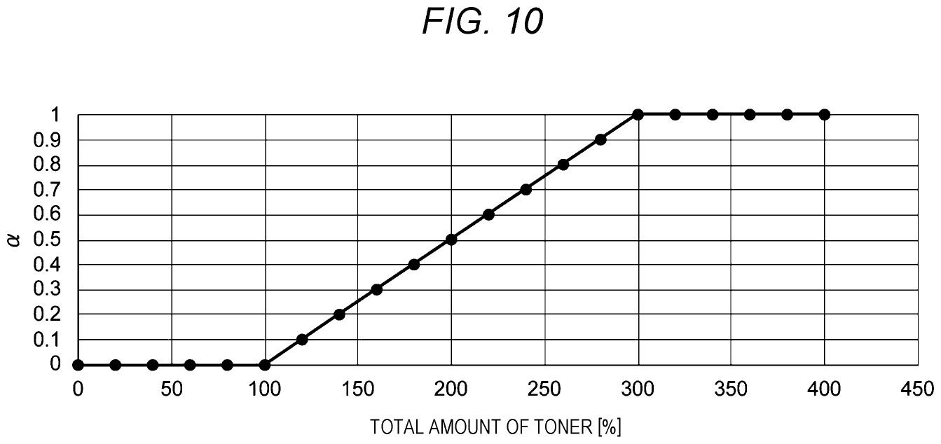

FIG. 10 is a graph illustrating a relationship between a and the total amount of toner for a sheet having a small change in surface characteristics.

The horizontal axis represents the total amount of toner, and the vertical axis represents α.

The unit of the horizontal axis is %, and the maximum value is 400%. The vertical axis represents a numerical value of 0 or more and 1 or less.

In FIG. 10, α is 0 when the total amount of toner is 0% to 100%.

When the total amount of toner is 100% to 300%, α linearly changes from 0 to 1.

When the total amount of toner is 300% to 400%, α is 1.

Varying the value of α in accordance with the total amount of toner, enables to bring the appearance of the sheet image closer to the appearance of the sheet image in accordance with the total amount of toner.

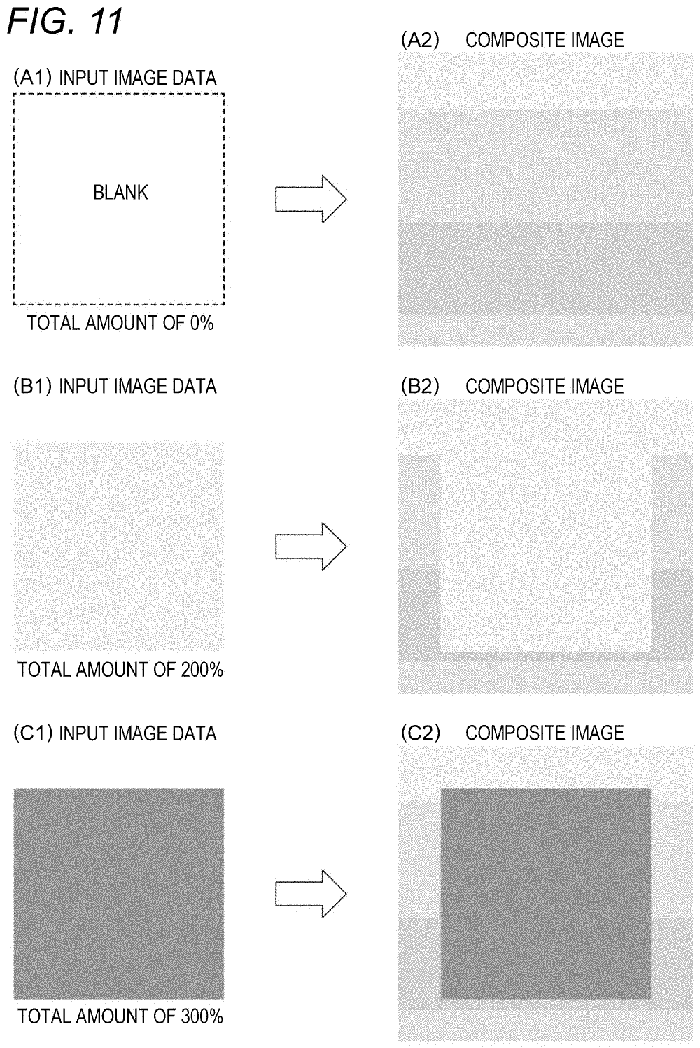

FIG. 11 is a diagram illustrating an example of generation of a composite image in which input image data is combined on a sheet having a small change in surface characteristics. (A1) illustrates an example of a pixel without input image data, (A2) illustrates an example of a composite image of pixels without input image data, (B1) illustrates an example of a pixel with a total amount of toner of 200% in input image data, (B2) illustrates an example of a composite image of pixels with a total amount of toner of 200%, (C1) illustrates an example of a pixel with a total amount of toner of 300% in input image data, and (C2) illustrates an example of a composite image of pixels with a total amount of toner of 300%.

(A1) and (A2) of FIG. 11 illustrate an input image and a composite image when the total amount of toner is 0%. In this case, only the sheet image is displayed as the preview image.

When the total amount of toner is in the range of 0% to 100%, α=0.

In this case, the RGB value and the glossiness of the composite image are given by the following expression.

RGB=DLUT [RGB]×sheet image data [RGB]

Glossiness=DLUT [glossiness]+(1−M)×sheet image data [glossiness]

When the total amount of toner is within this range, the proportion of the components of the sheet image in the RGB values is at least four times or more that in the case illustrated in (A2) of FIG. 8. Therefore, the sheet image is easily seen.

(B1) and (B2) of FIG. 11 illustrate an input image and a composite image when the total amount of toner is 200%.

In this case, the RGB value and the glossiness of the composite image are given by the following expression. From FIG. 10, α=0.5.

RGB=0.25×DLUT [RGB]+0.75×DLUT[RGB]×sheet image data [RGB]

Glossiness=DLUT [glossiness]+0.5×sheet image data [glossiness]

When the total amount of toner is 200%, the proportion of components of the sheet image in the RGB values is 1.5 times greater than that in the case illustrated in (B2) in FIG. 8. Therefore, the composite image illustrated in (B2) of FIG. 11 is more influenced by the sheet image than the composite image illustrated in (B2) of FIG. 8.

When the total amount of toner exceeds 100%, a gradually increases from 0 and reaches 1 when the total amount of the toner is 300%. Therefore, as the total amount of toner increases, the proportion of the sheet image in the RGB of the composite image decreases, whereas the proportion of the input image increases. As a result, it is possible to substantially eliminate the influence of the sheet image until the total amount of toner reaches 300%.

(C1) and (C2) of FIG. 11 illustrate an input image and a composite image when the total amount of toner is 300%.

In this case, the RGB value and the glossiness of the composite image are given by the following expression. Here, α=1.

RGB=0.75×DLUT [RGB]+0.25×DLUT [RGB]×sheet image data [RGB]

Glossiness=DLUT [glossiness]+0.2533 sheet image data [glossiness]

After α reaches 1, as the total amount of toner increases, the proportion of the input image increases, and conversely, the proportion of the sheet image decreases. As a result, a preview image close to the actual appearance can be displayed.

### <α is Variable Value/Sheet Having Large Change in Surface Characteristics>

Subsequently, a case where α is varied in accordance with the total amount of toner will be described.

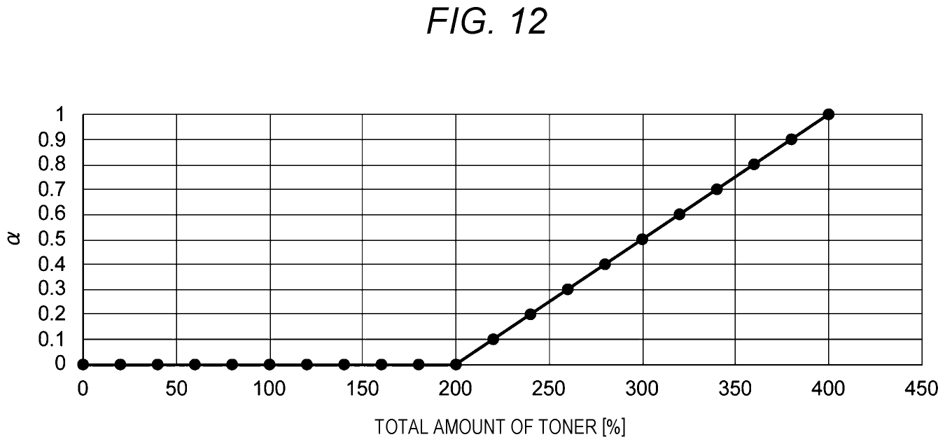

FIG. 12 is a graph illustrating a relationship between α and the total amount of toner for a sheet having a large change in surface characteristics.

The horizontal axis represents the total amount of toner, and the vertical axis represents α.

The unit of the horizontal axis is %, and the maximum value is 400%.

The vertical axis represents a numerical value of 0 or more and 1 or less.

In FIG. 12, α is 0 when the total amount of toner is 0% to 200%.

When the total amount of toner is 200% to 400%, α linearly changes from 0 to 1.

By varying the value of α in accordance with the total amount of toner, the appearance of the sheet image can be brought closer to the appearance of the sheet image in accordance with the total amount of toner.

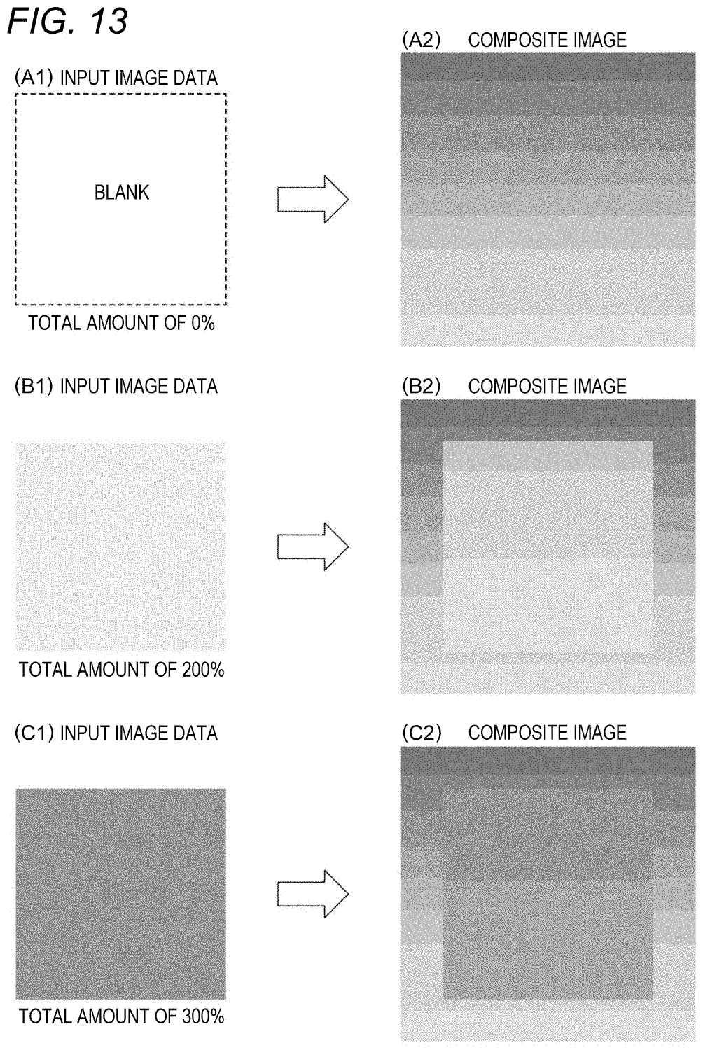

FIG. 13 is a diagram illustrating an example of generation of a composite image in which input image data is combined on a sheet having a large change in surface characteristics. (A1) illustrates an example of a pixel without input image data, (A2) illustrates an example of a preview image of pixels without input image data, (B1) illustrates an example of a pixel with a total amount of toner of 200% in input image data, (B2) illustrates an example of a preview image of pixels with a total amount of toner of 200%, (C1) illustrates an example of a pixel with a total amount of toner of 300% in input image data, and (C2) illustrates an example of a preview image of pixels with a total amount of toner of 300%.

(A1) and (A2) of FIG. 13 illustrate an input image and a composite image when the total amount of toner is 0%. In this case, only the sheet image is displayed as the preview image.

When the total amount of toner is in the range of 0% to 200%, α=0.

In this case, the RGB value and the glossiness of the composite image are given by the following expression.

RGB=DLUT [RGB]×sheet image data [RGB]

Glossiness=DLUT [glossiness]+(1−M)×sheet image data [glossiness]

When the total amount of toner is within this range, the proportion of the components of the sheet image in the RGB values are the same as those illustrated in (A2) of FIG. 11.

The same equation is applied until the total amount of toner becomes 200%.

(B1) and (B2) of FIG. 13 illustrate appearances of an input image and a composite image when the total amount of toner is 200%.

In this case, the RGB value and the glossiness of the composite image are given by the following expression. Here, α=0.

RGB=DLUT [RGB]×sheet image data [RGB]

Glossiness=DLUT [glossiness]+0.5×sheet image data [glossiness]

When the total amount of toner is 200%, the proportion of components of the sheet image in the RGB values is five times greater than that in the case illustrated in (B2) in FIG. 9. Therefore, in the composite image illustrated in (B2) of FIG. 13, the influence of the sheet image appears more than that in the composite image illustrated in (B2) of FIG. 9.

When the total amount of toner exceeds 200%, a gradually increases from 0 and reaches 1 when the total amount of the toner is 400%. Therefore, as the total amount of toner increases, the proportion of the sheet image in the RGB of the composite image decreases, whereas the proportion of the input image increases.

(C1) and (C2) of FIG. 13 illustrate an input image and a composite image when the total amount of toner is 300%.

In this case, the RGB value and the glossiness of the composite image are given by the following expression. Here, α=0.5.

RGB=0.375×DLUT [RGB]+0.625×DLUT [RGB]×sheet image data [RGB]

Glossiness=DLUT [glossiness]+0.25×sheet image data [glossiness]

In the case of a sheet having a large surface characteristic, α is still 0.5 even when the total amount of toner reaches 300%. Therefore, many components of the sheet image still remain in the composite image. Therefore, in the composite image illustrated in (C2) of FIG. 13, the influence of the sheet image appears more than that in the composite image illustrated in (C2) of FIG. 9.

However, since the total amount of toner is increased from 200% to 300%, more components of the input image appear in the composite image.

### <Second Exemplary Embodiment>

In the present exemplary embodiment, another example of combining input image data and sheet image data will be described.

A configuration of the printing system 1 (see FIG. 1) used in the second exemplary embodiment is the same as that of the first exemplary embodiment.

A hardware configuration and a functional configuration of the control apparatus 40 (see FIG. 1) used in the second exemplary embodiment are also the same as those of the first exemplary embodiment. The difference is only the processing content of the preview image by the preview image generator 421 (see FIG. 4).

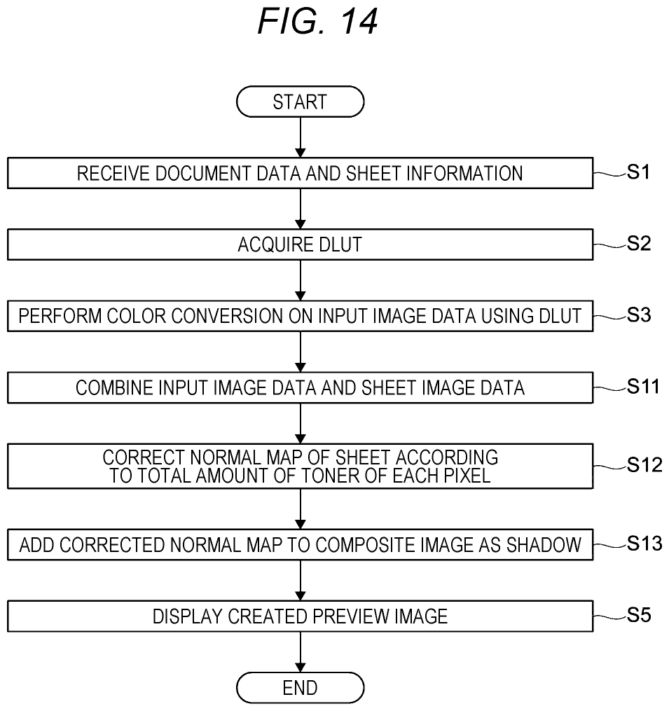

FIG. 14 is a flowchart illustrating an example of a processing operation related to the display of a preview image performed by the control apparatus 40. In FIG. 14, components corresponding to those in FIG. 5 are denoted by the same reference numerals.

Operations of step 1 to step 3 in the processing operation illustrated in FIG. 14 are the same as those in FIG. 5.

In the second exemplary embodiment, the processor 41 (see FIG. 2) combines the input image data and the sheet image data (step 11).

For example, the RGB value and the glossiness of the composite image are calculated by the following expression.

RGB=DLUT [RGB]×sheet image data [RGB]

Glossiness=DLUT [glossiness]+sheet image data [glossiness]

Next, the processor 41 corrects the normal map data of the sheet according to the total amount of toner of each pixel (step 12).

The normal map data to be corrected is predetermined as the sheet data 44B. The normal map data is different from the sheet image data and the glossiness data.

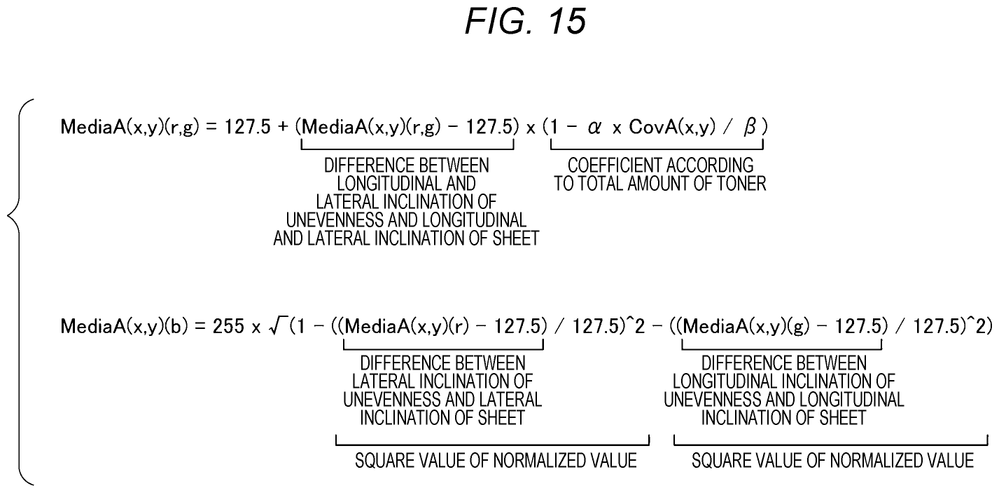

FIG. 15 is a diagram illustrating an example of an arithmetic expression used for correcting normal vector data used in step 12.

MediaA(x,y)(r,g)=127.5+(MediaA(x,y)(r,g)−127.5)×(1−α×Cov A(x,y)/β)

MediaA(x,y)(b)=255×√E

Here, E is given by the following expression.

Note that, E=1−E1\hat{ }2−E2\hat{ }2.

E1=(MediaA(x,y)(r)−127.5)/127.5.

E2=(MediaA(x,y)(g)−127.5)/127.5.

MediaA(x, y)(r, g, b) is a normal map of the sheet A. The normal map is an image in which the direction of the normal line at each position is represented by an RGB value, and represents the shadow of the sheet surface. The shadow is represented by unevenness, a flaw, a groove, or the like. The shadow indicates the unevenness feel of the surface of the sheet.

x indicates the position in the lateral direction of the sheet, and y indicates the position in the longitudinal direction of the sheet.

(r, g, b) is a normal vector. The distribution of the normal vectors expresses the surface unevenness of the sheet.

r is a component of a normal vector in the lateral direction of the sheet. Note that, 127 represents the same angle as that of the flat sheet.

g represents a component of a normal vector in the longitudinal direction of the sheet. Note that, 127 represents the same angle as that of the flat sheet.

b represents a component of a normal vector in the depth direction of the sheet. In a case where r and g are 127, a normal vector of a flat sheet is 255, and becomes a value smaller than 255 in accordance with changes in r and g.

Cov A(x, y) represents the total amount of toner corresponding to the position (x, y) in the input image data. Note that, Cov A(x, y)≤β is satisfied.

β is a maximum value of a total amount of the toner.

α satisfies 0≤α≤1.

α and β are fixed values, and are determined in accordance with, for example, the type of sheet, the particle diameter of toner, the layer thickness of toner having a density value of 100%, the transfer efficiency of toner with respect to sheet, and the fixing efficiency.

The value of MediaA(x, y)(r, g) is corrected to a value closer to the inclination of a flat sheet as the total amount of toner at the position specified by (x, y) increases. The component of the normal vector in the depth direction is calculated using the corrected magnitude of the component in the horizontal direction and the corrected magnitude of the component in the vertical direction.

As a result, at a position where the total amount of toner is larger, the unevenness is corrected to be lower than the actual height of the unevenness.

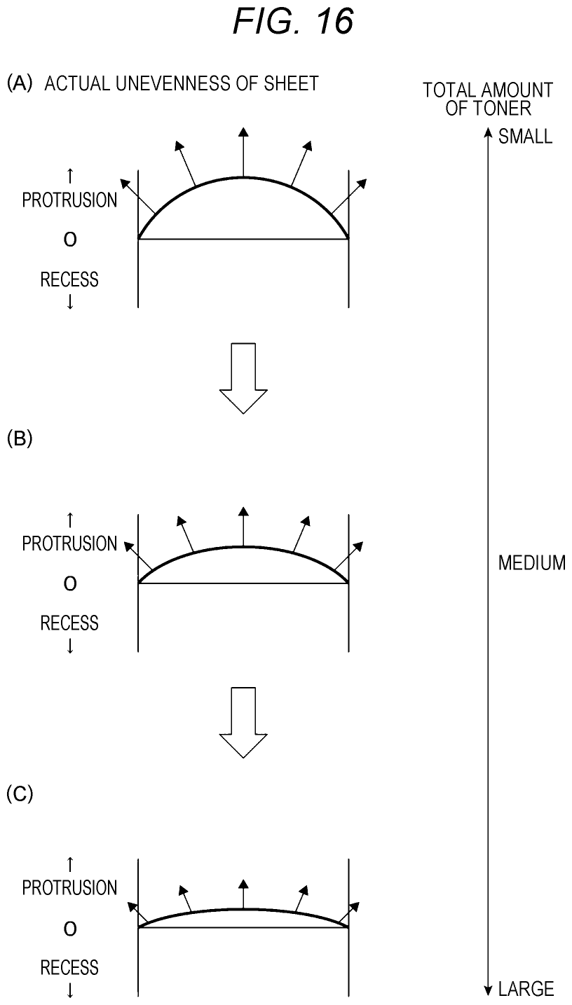

FIG. 16 is a diagram illustrating correction of the normal map. (A) illustrates an uneven shape in a case where the total amount of toner is small, (B) illustrates an uneven shape after correction in a case where the total amount of toner is medium, and (C) illustrates an uneven shape after correction in a case where the total amount of toner is large.

The uneven shape illustrated in (A) of FIG. 16 represents the actual uneven shape of the sheet.

As illustrated in (A) to (C) of FIG. 16, at a position where the total amount of toner is larger, the normal map is corrected to have an uneven shape lower than the actual unevenness of the sheet.

FIG. 14 will be described below again.

The processor 41 adds the corrected normal map to the composite image as a shadow (step 13).

In the conventional method, even in a place where the total amount of toner is large, the normal map (that is, the uneven waveform in (A) of FIG. 16) generated based on the actual unevenness of the sheet is added as the shadow. Therefore, a clear shadow is added to the composite image at a location where the masking effect is high.

On the other hand, in the present exemplary embodiment, in a place where the total amount of toner is large, a corrected uneven waveform illustrated in (C) of FIG. 16 is added as a shadow. For this reason, the shadow added to the composite image in the location where the masking effect is high is reduced, and the appearance becomes closer to the actual appearance of the printed matter.

Thereafter, the processor 41 displays the created preview image (step 5).

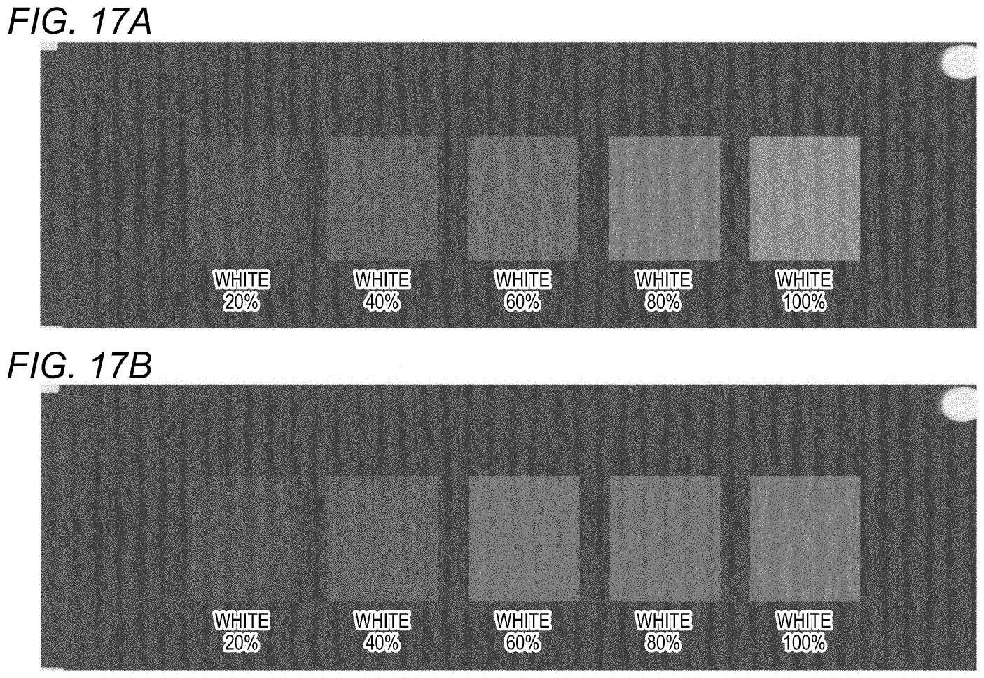

FIGS. 17A and 17B are diagrams each illustrating an example of preview images displayed when a plurality of patterns with different total toner amounts are printed on a sheet having unevenness formed on a surface thereof. FIG. 17A illustrates a display example in a case where the normal map data of the sheet is corrected and used, and FIG. 17B illustrates a display example in a case where the normal map data of the sheet is used as it is.

FIGS. 17A and 17B illustrate cases in which printing is performed by changing the density value of cyan (C) toner on the front side of a sheet. In this example, the density value is changed in six stages of 20%, 40%, 60%, 80%, and 100%.

In the preview image illustrated in FIG. 17A, when the total amount of toner is 80% or 100%, the shadow formed due to the unevenness of the base sheet is reduced.

On the other hand, in the preview image illustrated in FIG. 17B, even when the total amount of toner is 80% or 100%, a lot of shadows are formed due to the unevenness of the base sheet. Therefore, in the preview image illustrated in FIG. 17B, the preview image at the position where the total amount of toner is large is different from the actual appearance of the sheet.

### <Third Exemplary Embodiment>

In the present exemplary embodiment, the case in which the first and second exemplary embodiments are combined will be described.

A configuration of the printing system 1 (see FIG. 1) used in the third exemplary embodiment is the same as that of the first exemplary embodiment.

A hardware configuration and a functional configuration of the control apparatus 40 (see FIG. 1) used in the third exemplary embodiment are also the same as those of the first exemplary embodiment. The difference is only the processing content of the preview image by the preview image generator 421 (see FIG. 4).

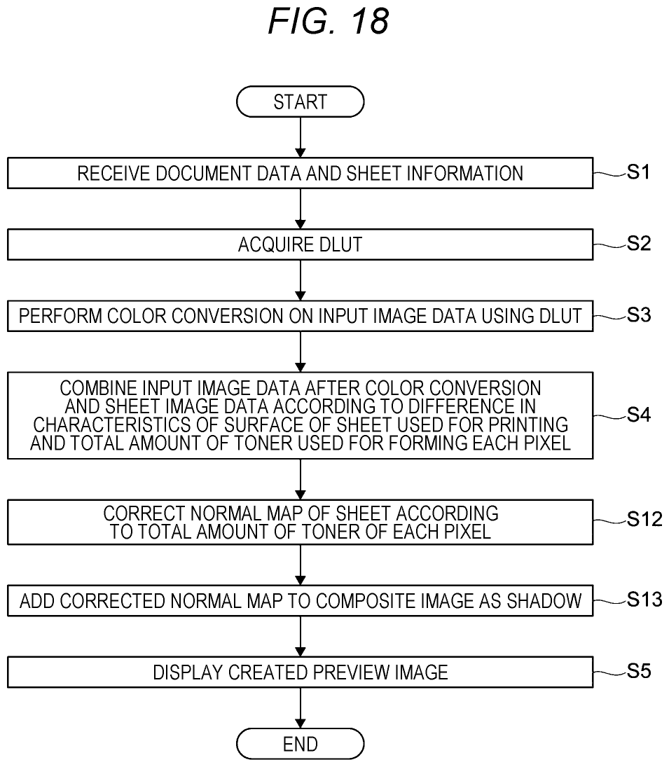

FIG. 18 is a flowchart illustrating an example of a processing operation related to the display of a preview image performed by the control apparatus 40. In FIG. 18, portions corresponding to FIGS. 5 and 14 are denoted by the same reference numerals.

In the case of the processing operation illustrated in FIG. 18, step 4 of FIG. 5 is used instead of step 11 of FIG. 14. Therefore, in the case of the third exemplary embodiment, it is possible to increase the proportion of components of the input image included in the composite image compared to the case of the second exemplary embodiment.

Of course, since the normal map added in step 13 becomes smaller as the total amount of toner increases, it becomes possible to further bring the appearance of the preview image closer to the actual appearance of the printed matter.

### <Other Exemplary Embodiments>

(1) Although the exemplary embodiments of the present invention have been described above, the technical scope of the present invention is not limited to the scope of the exemplary embodiments described above. It is clear from the descriptions in the claims that a variety of modifications or improvements may be made to the foregoing exemplary embodiment and such modifications and improvements may also fall within the technical scope of the present invention.

(2) Although the control apparatus 40 (see FIG. 1) is disposed at the upper part of the casing of the print apparatus 20 (see FIG. 1) in the foregoing exemplary embodiment, the control apparatus 40 may be implemented as an independent information processing apparatus, for example, a server, that is connected through a network or a signal line.

(3) The processor in the foregoing exemplary embodiment refers to a processor in a broad sense, and includes a general-purpose processor (for example, a CPU) and a dedicated processor (for example, a graphical processing unit (GPU), an application specific integrated circuit (ASIC), a field programmable gate array (FPGA), a program logic device, or the like).

In addition, the operation of the processor in each of the foregoing exemplary embodiments may be executed by one processor alone, but may be executed by a plurality of physically separated processors in cooperation with each other. In addition, the order in which the processor executes each operation is not limited to the order described in each of the foregoing exemplary embodiments, and may be individually changed.

What is claimed is:

1. A non-transitory computer readable recording medium recording program for causing a computer that reproduces an image of a printed matter before printing and displays the image on a screen to implement:
a changing function of, in a case where a first image generated according to a density value of a color material and a second image representing a surface of a sheet to be used for printing are combined to generate an image of a printed matter, changing appearance of the second image according to a total amount of the color material to be used for printing the corresponding first image, for each pixel position.

2. The non-transitory computer readable recording medium recording program according to claim 1,
wherein the changing function includes changing the appearance of the second image for each position when a characteristic of the surface of the sheet changes according to the position.

3. The non-transitory computer readable recording medium recording program according to claim 2,
wherein the changing function includes changing the appearance of the second image when a change in color density appearing on the surface of the sheet or a change in glossiness appearing on the surface of the sheet exceeds a reference.

4. The non-transitory computer readable recording medium recording program according to claim 2,
wherein the changing function includes changing the appearance of the second image when a change in unevenness feel appearing on the surface of the sheet exceeds a reference.

5. The non-transitory computer readable recording medium recording program according to claim 1,
wherein the changing function includes making a ratio at which the second image is combined inversely proportional to a size of the total amount of the color material used for printing the first image.

6. The non-transitory computer readable recording medium recording program according to claim 5,
wherein when the size of the total amount of the color material used for printing the first image is M, the changing function includes combining the first image and the second image at a ratio of M:1-M.

7. The non-transitory computer readable recording medium recording program according to claim 5,
wherein when the size of the total amount of the color material used for printing the first image is M, the changing function includes combining glossiness of the first image and glossiness of the second image at a ratio of 1:1-M.

8. The non-transitory computer readable recording medium recording program according to claim 1,
wherein the changing function includes correcting an unevenness feel of the surface of the sheet according to a size of the total amount of the color material used for printing the first image.

9. The non-transitory computer readable recording medium recording program according to claim 8,
wherein the changing function includes reducing the unevenness feel of the surface of the sheet as the total amount of the color material used for printing the first image increases.

10. An information processing apparatus comprising a processor,
wherein the processor
changes, in a case where a first image generated according to a density value of a color material and a second image representing a surface of a sheet to be used for printing are combined to generate an image of a printed matter, appearance of the second image according to a total amount of the color material to be used for printing the corresponding first image, for each pixel position.
